(19) United States
(12) Patent Application Publication
(10) Pub. No.: US 2018/0375737 A1
(43) Pub. Date: Dec. 27, 2018

(54) SENSOR ESTIMATION SERVER AND SENSOR ESTIMATION METHOD

(71) Applicant: Institute For Information Industry, Taipei (TW)

(72) Inventor: Chia-Ching WANG, Taipei City (TW)

(21) Appl. No.: 15/643,783

(22) Filed: Jul. 7, 2017

(30) Foreign Application Priority Data
Jun. 21, 2017 (TW) 106120734

(51) Int. Cl. H04L 12/24

(52) U.S. Cl. CPC H04L 41/12; H04L 67/12

(57) ABSTRACT

A sensor estimation server and a sensor estimation method thereof are provided. The sensor estimation server receives first sensor values of deploying sensors to each of servers from the servers, and receives added sensor values of deploying added sensor to each of the servers from the servers. The sensor estimation server calculates correlations between the added sensor and the sensors based on the added sensor values and the first sensor values, and selects target sensors accordingly. The sensor estimation server calculates estimation parameters according to the added sensor values and target sensor values of deploying the target sensors to each of servers. The sensor estimation server receives second sensor values of deploying the target sensors to under-test servers from the under-test servers, and calculates a sensor estimation value based on the estimation parameters and the second sensor values.

### PRIORITY

This application claims priority to Taiwan Patent Application No. 106120734 filed on Jun. 21, 2017, which is hereby incorporated by reference in its entirety.

### FIELD

The present invention relates to a sensor estimation server and a sensor estimation method; more particularly, the present invention relates to a sensor estimation server and a sensor estimation method for estimating sensors newly added into a system.

### BACKGROUND

Internet of Things (IoT) systems and Internet of People (IoP) systems developed as an extension of the IoT systems are network technologies that are currently developing actively. Through the technologies, sensors of different user equipments (UEs) can be connected in various networks to achieve communication and data exchange among the UEs so that users can obtain desired information.

With the development of the technologies, sensors of various UEs usually need to be introduced into a network system in order to satisfy requirements of different users. On the other hand, as the number of the users increases rapidly, the number of servers and the number of the sensors of the UEs in the network system also increase rapidly.

Considerable differences exist between different sensors in terms of the processing capability, performance and stability with respect to different systems thereof. Therefore, when a new sensor is introduced into the network system having multiple servers and sensors, a considerably high test cost and time cost are usually required to confirm the operation status of the new sensor itself for different servers in the system as well as the influence on the overall performance of the system imposed by the new sensor.

In this way, the overall cost of introducing new sensors into the network system is relatively high. Accordingly, an urgent need exists in the art to avoid the aforesaid drawbacks.

### SUMMARY

An objective is to provide a sensor estimation method for a sensor estimation server. The sensor estimation server is for use in a sensor system which can comprise a plurality of servers and a plurality of sensors. The sensor estimation method comprises: enabling the sensor estimation server to receive a plurality of first sensor values of deploying the sensors to each of the servers from the servers; enabling the sensor estimation server to receive a plurality of added sensor values of deploying an added sensor to each of the servers from the servers.

Then, enabling the sensor estimation server to calculate correlations between the added sensor and the sensors according to the added sensor values and the first sensor values; enabling the sensor estimation server to choose a plurality of target correlations from the correlations, wherein the target correlations correspond to a plurality of target sensors among the sensors; enabling the sensor estimation server to calculate a plurality of estimation parameters according to the added sensor values of deploying the added sensor to each of the servers and a plurality of target sensor values of deploying the target sensors to each of servers.

Thereafter, enabling the sensor estimation server to receive a plurality of second sensor values of deploying the target sensors to an under-test server from the under-test server; and enabling the sensor estimation server to calculate a sensor estimation value of deploying the added sensor to the under-test server according to the estimation parameters and the second sensor values.

The disclosure includes a sensor estimation server for use in a sensor system. The sensor system comprises a plurality of servers and a plurality of sensors. The sensor estimation server comprises a transceiver and a processor. The transceiver is configured to: receive a plurality of first sensor values of deploying the sensors to each of the servers from the servers; and receive a plurality of added sensor values of deploying an added sensor to each of the servers from the servers.

The processor can be configured to: calculate correlations between the added sensor and the sensors according to the added sensor values and the first sensor values; choose a plurality of target correlations from the correlations, wherein the target correlations correspond to a plurality of target sensors among the sensors; and calculate a plurality of estimation parameters according to the added sensor values of deploying the added sensor to each of the servers and a plurality of target sensor values of deploying the target sensors to each of servers.

The transceiver can be further configured to: receive a plurality of second sensor values of deploying the target sensors to an under-test server from the under-test server. The processor is further configured to calculate a sensor estimation value of deploying the added sensor to the under-test server according to the estimation parameters and the second sensor values.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a sensor estimation server applied to a sensor system according to a first embodiment of the present invention;

FIG. 1B is a block diagram of a sensor estimation server according to the first embodiment of the present invention;

FIG. 2A is a schematic view of a sensor estimation server applied to a sensor system according to a second embodiment of the present invention;

FIG. 2B is a block diagram of a sensor estimation server according to the second embodiment of the present invention; and

FIG. 3A to FIG. 3B are flowchart diagrams of a sensor estimation method according to a third embodiment of the present invention.

### DETAILED DESCRIPTION

In the following description, the present invention will be explained with reference to certain example embodiments thereof. However, these example embodiments are not intended to limit the present invention to any particular examples, embodiments, environment, applications or implementations described in these example embodiments. Therefore, description of these example embodiments is only for purpose of illustration rather than to limit the present invention.

In the following example embodiments and the attached drawings, elements unrelated to the present invention are omitted from depiction; and dimensional relationships among individual elements in the attached drawings are illustrated only for ease of understanding, but not to limit the actual scale.

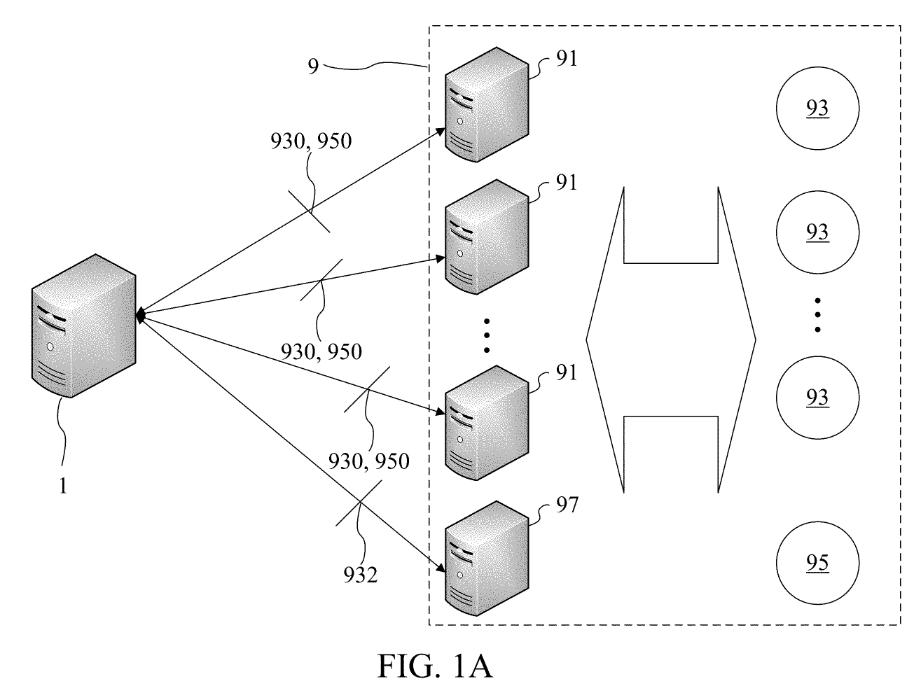

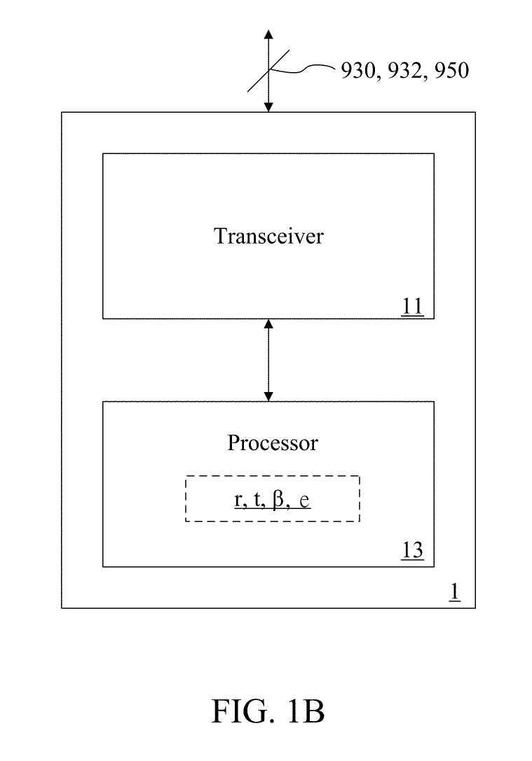

Please refer to FIG. 1A to FIG. 1B. FIG. 1A is a schematic view of a sensor estimation server 1 applied to a sensor system 9 according to a first embodiment of the present invention. The sensor system 9 comprises a plurality of servers 91 and a plurality of sensors 93. FIG. 1B is a block diagram of a sensor estimation server 1 according to the first embodiment of the present invention. The sensor estimation server 1 comprises a transceiver 11 and a processor 13. The elements are electrically connected together, and interactions among the elements will be further described hereinafter.

First, the transceiver 11 of the sensor estimation server 1 receives a plurality of first sensor values 930 of deploying the sensors 93 to each of the servers 91 from the servers 91, and receives a plurality of added sensor values 950 of deploying an added sensor 95 to each of the servers 91 from the servers 91.

Next, the processor 13 of the sensor estimation server 1 can calculate correlations r between the added sensor 95 and the sensors 93 according to the added sensor values 950 and the first sensor values 930. A corresponding correlation r exists between the added sensor 95 and a single sensor 93 for representing the level of similarity between the added sensor 95 and the sensor 93.

Thereafter, the processor 13 chooses a plurality of target correlations t from the correlations r. Those of the sensors 93 that correspond to the target correlations t are target sensors of a higher level of similarity with the added sensor 95, and those of the first sensor values 930 of deploying the target sensors to the each of the servers 93 are target sensor values. Accordingly, the processor 13 calculates a plurality of estimation parameters β according to the target sensor values and the added sensor values 950.

When the sensor estimation server 1 intends to estimate the use status of the added sensor 95 in an under-test server 97, the transceiver 11 first receives a plurality of second sensor values 932 of deploying the target sensors to the under-test server 97 from the under-test server 97. In this way, the processor 13 can calculate a sensor estimation value e of deploying the added sensor 95 to the under-test server 97 according to the estimation parameters β and the second sensor values 932.

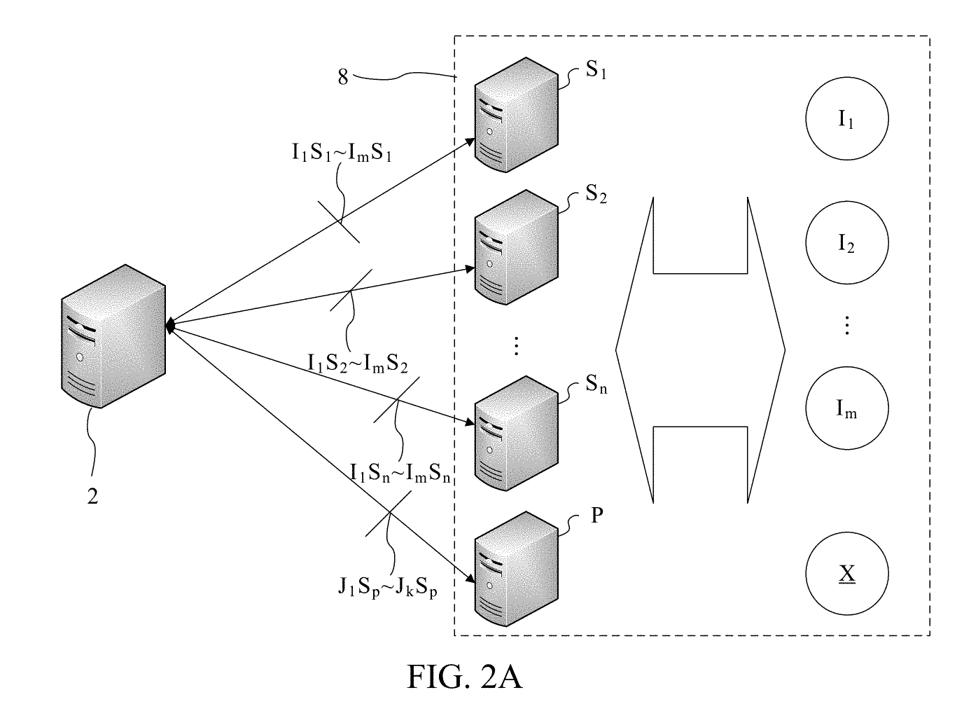

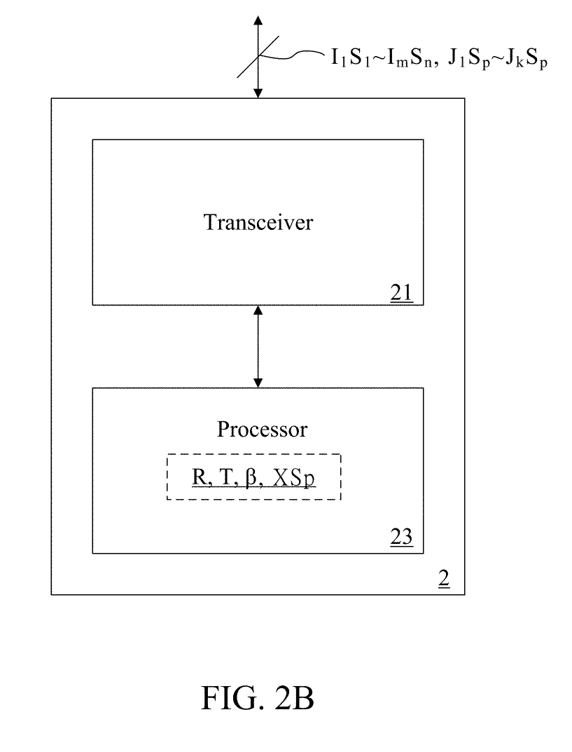

Please refer to FIG. 2A to FIG. 2B. FIG. 2A is a schematic view of a sensor estimation server 2 applied to a sensor system 8 according to a second embodiment of the present invention. The sensor system 8 comprises a plurality of servers S₁ to Sₙ and a plurality of sensors I₁ to Iₘ. FIG. 2B is a block diagram of a sensor estimation server 2 according to the second embodiment of the present invention. The sensor estimation server 2 comprises a transceiver 21 and a processor 23. The second embodiment mainly further describes the estimation operation in detail.

First, the transceiver 21 of the sensor estimation server 2 receives a plurality of first sensor values I₁S₁ to IₘSₙ of deploying the sensors I₁ to Iₘ to each of the servers S₁ to Sₙ from the servers S₁ to Sₙ respectively (referring to Table 1 below), and receives a plurality of added sensor values XS₁ to XSₙ of deploying an added sensor X to each of the servers S₁ to Sₙ from the servers S₁ to Sₙ respectively (referring to Table 2 below).

TABLE 1

| | I₁ | I₂ | I₃ | . . . | Iₘ |
|---|---|---|---|---|---|
| S₁ | I₁S₁ | I₂S₁ | I₃S₁ | . . . | IₘS₁ |
| S₂ | I₁S₂ | I₂S₂ | I₃S₂ | . . . | IₘS₂ |
| S₃ | I₁S₃ | I₂S₃ | I₃S₃ | . . . | IₘS₃ |
| . . . | . . . | . . . | . . . | . . . | . . . |
| Sₙ | I₁Sₙ | I₂Sₙ | I₃Sₙ | . . . | IₘSₙ |

TABLE 2

| | X |
|---|---|
| S₁ | XS₁ |
| S₂ | XS₂ |
| S₃ | XS₃ |
| . . . | . . . |
| Sₙ | XSₙ |

It shall be particularly appreciated that, in the second embodiment, each of the aforesaid sensor values may be one of a sensor response time, a sensor delay time, a sensor computation time or a sensor data transmission amount, and may be stored into the sensor estimation server 2 by means of a multidimensional matrix. However, this is not intended to limit the implementation of data storage in the present invention.

Next, the processor 23 of the sensor estimation server 2 can calculate correlations R₁ to Rₘ between the added sensor X and the sensors I₁ to Iₘ according to the added sensor values XS₁ to XSₙ and the first sensor values I₁S₁ to IₘSₙ. Specifically, the processor 23 calculates the correlations R₁ to Rₘ between the added sensor X and the sensors I₁ to Iₘ based on the Pearson Correlation Coefficient formula according to the added sensor values XS₁ to XSₙ and the first sensor values I₁S₁ to IₘSₙ.

Further speaking, the correlations with respect to different sensors Iₘ can be calculated through the following Pearson Correlation Coefficient formula mainly according to the added sensor values XS₁ to XSₙ:

$${R}_{m} = \frac{{\sum }_{i = 1}^{n} ( {XS}_{i} - \overline{XS} ) ( {I}_{m} {S}_{i} - \overline{{I}_{m} S} )}{\sqrt{{\sum }_{i = 1}^{n} {( {XS}_{i} - \overline{XS} )}^{2}} \sqrt{{\sum }_{i = 1}^{n} {( {I}_{m} {S}_{i} - \overline{{I}_{m} S} )}^{2}}}$$

where, Rₘ ranges between [−1, 1], and a larger value thereof represents a higher level of similarity. In other words, if the Rₘ is closer to 1, then it means that the added sensor X is more similar to the sensor Iₘ, i.e., the two sensors are more alike in property.

Thereafter, the processor 23 chooses positive correlations from the correlations R₁ to Rₘ (i.e., chooses correlations of which the value ranges from 0 to 1) to preliminarily choose sensors of a high level of similarity. Next, the processor 23 filters extreme values for those of the first sensor values corresponding to those of the sensors that correspond to the chosen positive correlations. For example, when Rₘ is the positive correlation, the processor 23 filters extreme values for the first sensor values IₘS₁ to IₘSₙ corresponding to the sensor Iₘ that corresponds to the correlation Rₘ, thereby preventing the correlations from being compromised due to error data.

Next, the processor 23 calculates a plurality of updated correlations (not shown) between those of the sensors and the added sensors XS₁ to XSₙ through the aforesaid Pearson Correlation Coefficient formula according to the added sensor values XS₁ to XSₙ and those of the first sensor values that remain after the filtering. Thereafter, the processor 23 sorts the updated correlations, and chooses a plurality of target correlations T₁ to Tₖ from the sorted updated correlations according to a memory threshold (not shown).

In more detail, in order to prevent the data amount of the sensor that needs to be processed from exceeding the data amount that can be processed in real time by the memory of the sensor estimation sensor 2 and thereby lowering the overall performance, the processor 23 determines that the processable data amount of the sensors corresponding to the first K correlations is less than the memory threshold after sorting the updated correlations.

Accordingly, the sensors corresponding to the K target correlations T₁ to Tₖ chosen by the processor 23 through the aforesaid method are a plurality of target sensors J₁ to Jₖ (included in the sensors I₁ to Iₘ) of the highest level of similarity with the added sensor X, and the sensor estimation server 2 can process the data amount of the sensors J₁ to Jₖ in real time. The sensor values of deploying the target sensors J₁ to Jₖ to each of the servers S₁ to Sₙ are target sensor values J₁S₁ to JₖSₙ (included in the sensor values I₁S₁ to IₘSₙ).

Thereafter, the processor 23 calculates a plurality of estimation parameters β₀ to βₖ according to the target sensor values J₁S₁ to JₖSₙ and the added sensor values XS₁ to XSₙ. Specifically, the processor 23 calculates the estimation parameters based on the following regression formula:

XSᵢ=β₀+β₁×J₁Sᵢ+β₂×J₂Sᵢ+ . . . +βₖ×JₖSᵢ

where, i is the number of the servers, and XSᵢ is the added sensor value of deploying the added sensor X to an i^{th} server. k is the number of the target sensors J₁ to Jₖ. J₁Sᵢ to JₖSᵢ are the target sensor values of deploying the target sensors J₁ to Jₖ to the i^{th} server. β₀ to βₖ are the estimation parameters.

In more detail, since XSi, k, and J₁Sᵢ to JₖSᵢ are known values, k+1 formulas can be listed through the aforesaid regression formula after k+1 servers are chosen from the servers S₁ to Sₙ, thereby obtaining the estimation parameters β₀ to βₖ. Accordingly, when the processor 23 intends to estimate the use status of the added sensor X in an under-test server P, the transceiver 21 first receives a plurality of second sensor values J₁Sₚ to JₖSₚ of deploying the target sensors J₁ to Jₖ to the under-test server P from the under-test server P.

Accordingly, the processor 13 can calculate a sensor estimation value XSₚ of deploying the added sensor X to the under-test server P based on the following regression formula according to the estimation parameters β₀ to βₖ and the second sensor values J₁Sₚ to JₖSₚ:

XSₚ=β₀+β₁×J₁Sₚ+β₂×J₂Sₚ+ . . . +βₖ×JₖSₚ

In this way, the sensor estimation server 2 can estimate possible relevant sensor values of deploying the added sensor X to the under-test server P.

It shall be further particularly appreciated that, the sensor estimation server 2 of the second embodiment of the present invention may also provide server associated information to the user as reference for potential influence on the server performance imposed by the added sensor X, in addition to estimating possible relevant sensor values of deploying the added sensor X to the server.

In detail, the transceiver 21 of the sensor estimation server 2 may further receive a plurality of pieces of performance difference information D(1,1) to D(k,n) of connecting the target sensors J₁ to Jₖ to the servers S₁ to Sₙ from the servers S₁ to Sₙ. For example, the server S₁ records a first sensor value sum before the target sensor J₁ connects to the server S₁, and the server S₁ records a second sensor value sum after the target sensor J₁ connects to the server S₁. At this point, the performance difference information D(1,1) is a ratio of the second sensor value sum to the first sensor value sum, and a larger value thereof means a larger influence on the performance of the server S₁ caused by joining the target sensor J₁ to the server S₁.

Since the similarity between the added sensor X and the target sensor J₁ to Jₖ is very high, the processor 23 decides a plurality of pieces of performance difference information d(x,1) to d(x,n) of connecting the added sensor X to the servers S₁ to Sₙ according to the plurality of pieces of performance difference information D(1,1) to D(k,n) of connecting the target sensors J₁ to Jₖ to the servers S₁ to Sₙ, and provides the performance difference information d(x,1) to d(x,n) to the user as reference for the influence on the overall performance of the servers S₁ to Sₙ imposed by the added sensor X.

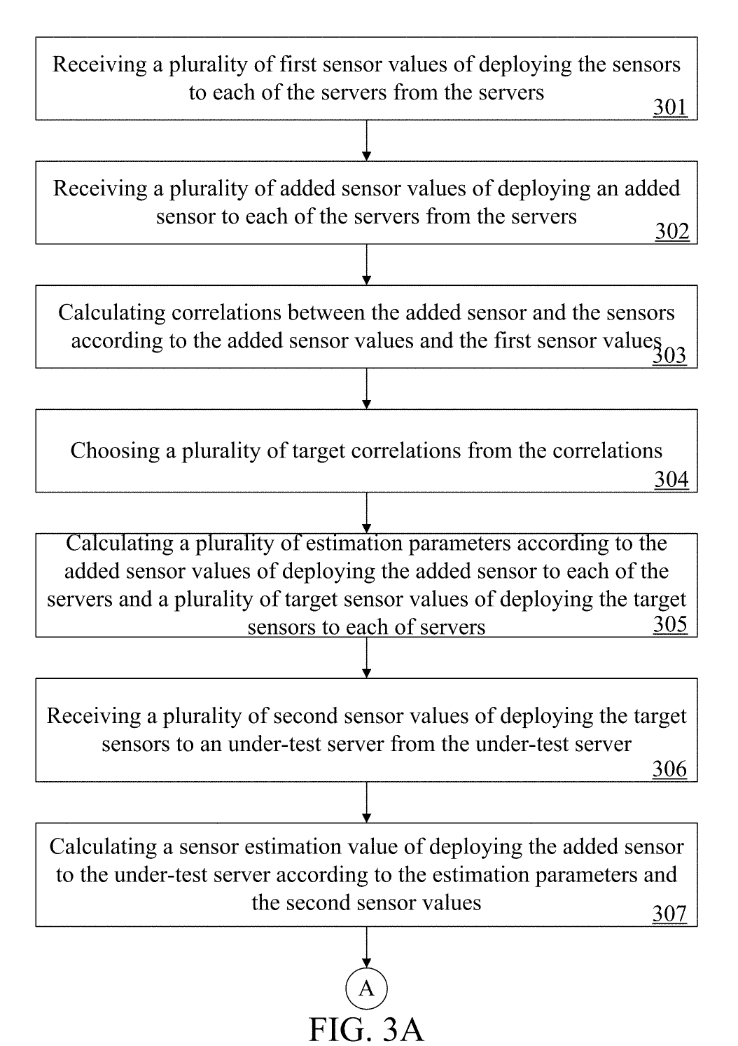

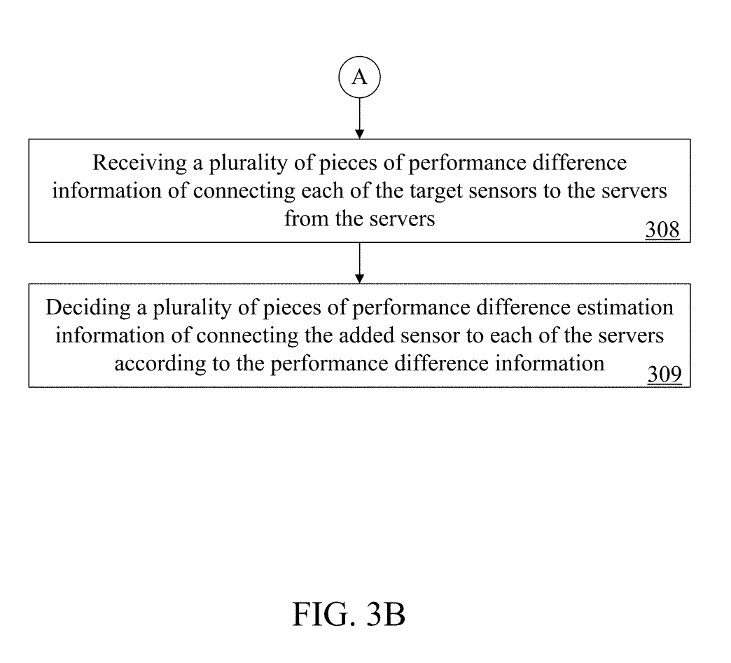

A third embodiment of the present invention is a sensor estimation method, and a flowchart diagram thereof is as shown in FIG. 3A. The method of the third embodiment is for use in a sensor estimation server (e.g., the sensor estimation server 1 of the aforesaid embodiments). The sensor estimation server is for use in a sensor system, and the sensor system comprises a plurality of servers and a plurality of sensors. Detailed steps of the third embodiment are as follows.

First, step 301 is executed to enable the sensor estimation server to receive a plurality of first sensor values of deploying the sensors to each of the servers from the servers. Step 302 is executed to enable the sensor estimation server to receive a plurality of added sensor values of deploying an added sensor to each of the servers from the servers.

Step 303 is executed to enable the sensor estimation server to calculate correlations between the added sensor and the sensors according to the added sensor values and the first sensor values. Step 304 is executed to enable the sensor estimation server to choose a plurality of target correlations from the correlations. The target correlations correspond to a plurality of target sensors among the sensors.

Step 305 is executed to enable the sensor estimation server to calculate a plurality of estimation parameters according to the added sensor values of deploying the added sensor to each of the servers and a plurality of target sensor values of deploying the target sensors to each of servers. Step 306 is executed to enable the sensor estimation server to receive a plurality of second sensor values of deploying the target sensors to an under-test server from the under-test server. Finally, step 307 is executed to enable the sensor estimation server to calculate a sensor estimation value of deploying the added sensor to the under-test server according to the estimation parameters and the second sensor values.

It shall be particularly appreciated that, the aforesaid step 303 may further comprise enabling the sensor estimation server to calculate the correlations between the added sensor and the sensors based on the Pearson Correlation Coefficient formula according to the added sensor values and the first sensor values. The added sensor pairing with one of the sensors corresponds to one of the correlations.

Similarly, the aforesaid step 304 may further comprise first enabling the sensor estimation server to choose positive correlations from the correlations, and then enabling the sensor estimation server to filter extreme values for those of the first sensor values corresponding to those of the sensors that correspond to the chosen positive correlations. Thereafter, the sensor estimation server is enabled to calculate a plurality of updated correlations between those of the sensors and the added sensor according to the added sensor values and those of the first sensor values that remain after the filtering.

Finally, the sensor estimation server is enabled to sort the updated correlations, and choose the target correlations from the sorted updated correlations according to a memory threshold. A processable data amount of the target sensors corresponding to the target correlations is less than the memory threshold.

Additionally, the step 305 may further comprise enabling the sensor estimation server to calculate the estimation parameters based on the following regression formula according to the target sensor values of deploying the target sensors to each of the servers and the added sensor values of deploying the added sensor to each of the servers:

XSᵢ=β₀+β₁×J₁Sᵢ+β₂×J₂Sᵢ+ . . . +βₖ×JₖSᵢ

where, i is the number of the servers, XSᵢ is the added sensor value of deploying the added sensor to an i^{th} server, k is the number of the target sensors, J₁Sᵢ, J₂Sᵢ, . . . , JₖSᵢ are the target sensor values of deploying the target sensors to the i^{th} server, and β₀, β₁, . . . , βₖ are the estimation parameters.

Accordingly, the step 307 may further comprise enabling the sensor estimation server to calculate the sensor estimation value based on the following regression formula according to the estimation parameters and the second sensor values:

XSₚ=β₀+β₁×J₁Sₚ+β₂×J₂Sₚ+ . . . +βₖ×JₖSₚ

where, J₁Sₚ, J₂Sₚ, . . . , JₖSₚ are the second sensor values, and XSₚ is the sensor estimation value.

Similarly, the sensor estimation method of the third embodiment of the present invention may further comprise a server performance estimation step, and a flowchart diagram thereof is as shown in FIG. 3B. Specifically, step 308 is executed to enable the sensor estimation server to receive a plurality of pieces of performance difference information of connecting each of the target sensors to the servers from the servers.

In detail, the plurality of pieces of performance difference information comprises first performance difference information. One of the servers B records a first sensor value sum before one of the target sensors A connects to the server B. The server B records a second sensor value sum after the target sensor A connects to the server B. The first performance difference information is a ratio of the second sensor value sum to the first sensor value sum.

Similarly, since the similarity between the added sensor and the target sensors is very high, step 309 is executed to enable the sensor estimation server to decide a plurality of pieces of performance difference estimation information of connecting the added sensor to each of the servers according to the plurality of pieces of performance difference information. The performance difference estimation information is provided to the user as reference for the influence on the overall performance of each of the servers imposed by the added sensor.

According to the above descriptions, the sensor estimation server and the sensor estimation method thereof according to the present invention first find sensors of a relatively high level of similarity with the added sensor, and then estimate sensor values of deploying the added sensor to different servers according to the sensor values of the sensors of the relatively high level of similarity and the regression method. Meanwhile, potential influence on the performance of the server imposed by the added sensor may also be determined through the influence on the overall performance of the server imposed by the sensors similar to the added sensor. In this way, the overall cost of introducing new sensors into the network system is greatly reduced, thereby effectively improving the drawbacks in the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A sensor estimation method for a sensor estimation server, the sensor estimation server being used in a sensor system that comprises a plurality of servers and a plurality of sensors, the sensor estimation method comprising:
the sensor estimation server receiving a plurality of first sensor values of deploying the sensors to each of the servers from the servers;
the sensor estimation server receiving a plurality of added sensor values of deploying an added sensor to each of the servers from the servers;
the sensor estimation server calculating correlations between the added sensor and the sensors according to the added sensor values and the first sensor values;
the sensor estimation server choosing a plurality of target correlations from the correlations, wherein the target correlations correspond to a plurality of target sensors among the sensors;
the sensor estimation server calculating a plurality of estimation parameters according to the added sensor values of deploying the added sensor to each of the servers and a plurality of target sensor values of deploying the target sensors to each of servers;
the sensor estimation server receiving a plurality of second sensor values of deploying the target sensors to an under-test server from the under-test server; and
the sensor estimation server calculating a sensor estimation value of deploying the added sensor to the under-test server according to the estimation parameters and the second sensor values.

2. The sensor estimation method of claim 1, further comprising:
the sensor estimation server receiving a plurality of pieces of performance difference information of connecting each of the target sensors to the servers from the servers;
the sensor estimation server deciding a plurality of pieces of performance difference estimation information of connecting the added sensor to each of the servers according to the plurality of pieces of performance difference information.

3. The sensor estimation method of claim 2, wherein the plurality of pieces of performance difference information comprises first performance difference information, one of the servers records a first sensor value sum before one of the target sensors connects to the one of the servers, the one of the servers records a second sensor value sum after the one of the target sensors connects to the one of the servers, and the first performance difference information is a ratio of the second sensor value sum to the first sensor value sum.

4. The sensor estimation method of claim 1, wherein the first sensor values, the added sensor value, and the second sensor values are a sensor response time, a sensor delay time, a sensor computation time or a sensor data transmission amount.

5. The sensor estimation method of claim 1, wherein the step of calculating correlations between the added sensor and the sensors further comprises:
the sensor estimation server calculating the correlations between the added sensor and the sensors based on the Pearson Correlation Coefficient formula according to the added sensor values and the first sensor values, wherein the added sensor pairing with one of the sensors corresponds to one of the correlations.

6. The sensor estimation method of claim 5, wherein the step of choosing the target correlations further comprises:
the sensor estimation server choosing positive correlations from the correlations;
the sensor estimation server filtering extreme values for those of the first sensor values corresponding to those of the sensors that correspond to the chosen positive correlations;
the sensor estimation server calculating a plurality of updated correlations between those of the sensors and the added sensor according to the added sensor values and those of the first sensor values that remain after the filtering; and
the sensor estimation server sorting the updated correlations, and choosing the target correlations from the sorted updated correlations according to a memory threshold, wherein a processable data amount of the target sensors corresponding to the target correlations is less than the memory threshold.

7. The sensor estimation method of claim 1, wherein step of calculating the estimation parameters further comprises:
the sensor estimation server calculating the estimation parameters based on the following regression formula according to the target sensor values of deploying the target sensors to each of the servers and the added sensor values of deploying the added sensor to each of the servers:
XSᵢ=β₀+β₁×J₁Sᵢ+β₂×J₂Sᵢ+ . . . +βₖ×JₖSᵢ
where, i is the number of the servers, XSᵢ is the added sensor value of deploying the added sensor to an i^{th} server, k is the number of the target sensors, J₁Sᵢ, J₂Sᵢ, . . . , JₖSᵢ are the target sensor values of deploying the target sensors to the i^{th} server, and β₀, β₁, . . . , βₖ are the estimation parameters;
wherein calculating the sensor estimation value of deploying the added sensor to the under-test server further comprises:
the sensor estimation server calculating the sensor estimation value based on the following regression formula according to the estimation parameters and the second sensor values:
XSₚ=β₀+β₁×J₁Sₚ+β₂×J₂Sₚ+ . . . +βₖ×JₖSₚ
where, J₁Sₚ, J₂Sₚ, . . . , JₖSₚ are the second sensor values, and XSₚ is the sensor estimation value.

8. A sensor estimation server for use in a sensor system, the sensor system comprising a plurality of servers and a plurality of sensors, the sensor estimation server comprising:
a transceiver, being configured to:
receive a plurality of first sensor values of deploying the sensors to each of the servers from the servers;
receive a plurality of added sensor values of deploying an added sensor to each of the servers from the servers;
a processor, being configured to:
calculate correlations between the added sensor and the sensors according to the added sensor values and the first sensor values;
choose a plurality of target correlations from the correlations, wherein the target correlations correspond to a plurality of target sensors among the sensors;
calculate a plurality of estimation parameters according to the added sensor values of deploying the added sensor to each of the servers and a plurality of target sensor values of deploying the target sensors to each of servers;
wherein the transceiver is further configured to:
receive a plurality of second sensor values of deploying the target sensors to an under-test server from the under-test server;
and wherein the processor is further configured to:
calculate a sensor estimation value of deploying the added sensor to the under-test server according to the estimation parameters and the second sensor values.

9. The sensor estimation server of claim 8, wherein the transceiver is further configured to receive a plurality of pieces of performance difference information of connecting each of the target sensors to the servers;
and wherein the processor is further configured to:
decide a plurality of pieces of performance difference estimation information of connecting the added sensor to each of the servers according to the plurality of pieces of performance difference information.

10. The sensor estimation server of claim 9, wherein the plurality of pieces of performance difference information comprises first performance difference information, one of the servers records a first sensor value sum before one of the target sensors connects to the one of the servers, the one of the servers records a second sensor value sum after the one of the target sensors connects to the one of the servers, and the first performance difference information is a ratio of the second sensor value sum to the first sensor value sum.

11. The sensor estimation server of claim 8, wherein the first sensor values, the added sensor value, and the second sensor values are a sensor response time, a sensor delay time, a sensor computation time or a sensor data transmission amount.

12. The sensor estimation server of claim 8, wherein the processor is further configured to calculate the correlations between the added sensor and the sensors based on the Pearson Correlation Coefficient formula according to the added sensor values and the first sensor values, wherein the added sensor pairing with one of the sensors corresponds to one of the correlations.

13. The sensor estimation server of claim 12, wherein the processor is further configured to:
choose positive correlations from the correlations;
filter extreme values for those of the first sensor values corresponding to those of the sensors that correspond to the chosen positive correlations;
calculate a plurality of updated correlations between those of the sensors and the added sensor according to the added sensor values and those of the first sensor values that remain after the filtering; and
sort the updated correlations, and choose the target correlations from the sorted updated correlations according to a memory threshold, wherein a processable data amount of the target sensors corresponding to the target correlations is less than the memory threshold.

14. The sensor estimation server of claim 8, wherein the processor is further configured to:
calculate the estimation parameters based on the following regression formula according to the target sensor values of deploying the target sensors to each of the servers and the added sensor values of deploying the added sensor to each of the servers:
XSᵢ=β₀+β₁×J₁Sᵢ+β₂×J₂Sᵢ+ . . . +βₖ×JₖSᵢ
where, i is the number of the servers, XSᵢ is the added sensor value of deploying the added sensor to an i^{th} server, k is the number of the target sensors, J₁Sᵢ, J₂Sᵢ, . . . , JₖSᵢ are the target sensor values of deploying the target sensors to the i^{th} server, and β₀, β₁, . . . , βₖ are the estimation parameters;
wherein calculating the sensor estimation value of deploying the added sensor to the under-test server further comprises:
calculating the sensor estimation value based on the following regression formula according to the estimation parameters and the second sensor values:
XSₚ=β₀+β₁×J₁Sₚ+β₂×J₂Sₚ+ . . . +βₖ×JₖSₚ
where, J₁Sₚ, J₂Sₚ, . . . , JₖSₚ are the second sensor values, and XSₚ is the sensor estimation value.
